(19) United States
(12) Patent Application Publication
(10) Pub. No.: US 2009/0061923 A1
(43) Pub. Date: Mar. 5, 2009

(54) MOBILE COMMUNICATION DEVICE HAVING SLOPED EAR PORTION

(75) Inventors: LORENZO A. PONCE DE LEON, LAKE WORTH, FL (US); ALEJANDRO CANDAL, DAVIE, FL (US); JOSE M. GONZALEZ, MIAMI, FL (US); RYAN M. NILSEN, POMPANO BEACH, FL (US); ERIC S. PENROD, PLANTATION, FL (US); MONIKA R. WOLF, PARKLAND, FL (US); PAUL BOSVELD, FORT LAUDERDALE, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/848,809

(22) Filed: Aug. 31, 2007

(51) Int. Cl. H04M 1/00

(52) U.S. Cl. 455/550.1

(57) ABSTRACT

A mobile communication device 100 has a user interface portion (102) and an ear portion (104). The ear portion slopes or curves away from a plane (202) defined by the user interface portion to urge a user of the mobile communication device to hold the mobile communication device at an angle (404).

### FIELD OF THE INVENTION

The invention relates generally to mobile communication devices, and more particularly to designs for improving the radio frequency performance when used during a call.

### BACKGROUND OF THE INVENTION

Mobile communication devices are in widespread use throughout the world, and are especially prevalent in metropolitan regions. There are several design and ergonomic factors which can affect the market success of a given mobile communication device design. Presently, for example, there is a trend to use internal antennas in some markets. Users may prefer the lack of an external antenna for a variety of reasons, but an internal antenna present a substantial challenge to the radio frequency performance of the mobile communication device to the designers and manufacturers of mobile communication devices.

Radio frequency performance is affected by the capacitive grounding effect of being in proximity to the user. Generally, it is preferable to locate the antenna as far from the user as possible, which is why extendible antennas have an advantage over internal antennas. Thus, there is a need for a design which enhances the radio frequency performance of a mobile communication device when the mobile communication device uses an internal antenna.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 shows a front elevational view of a mobile communication device having a sloped ear portion, in accordance with an embodiment of the invention;

FIG. 2 shows a side elevational view of a mobile communication device having a sloped ear portion, in accordance with an embodiment of the invention;

FIG. 3 shows a use diagram of a prior art mobile communication device;

FIG. 4 shows a use diagram of a mobile communication device designed in accordance with the invention;

FIG. 5 shows a clamshell mobile communication device adapted to incorporate an embodiment of the invention;

FIG. 6 shows a side cut-away view of an ear portion of a mobile communication device, in accordance with an embodiment of the invention;

FIG. 7 shows a side cut-away view of an ear portion of a mobile communication device, in accordance with an alternate embodiment of the invention;

FIG. 8 shows a side cut-away view of an ear portion of a mobile communication device, in accordance with an alternate embodiment of the invention; and

FIG. 9 shows a side view of a slider type mobile communication device, in accordance with an embodiment of the invention.

### DETAILED DESCRIPTION OF THE INVENTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

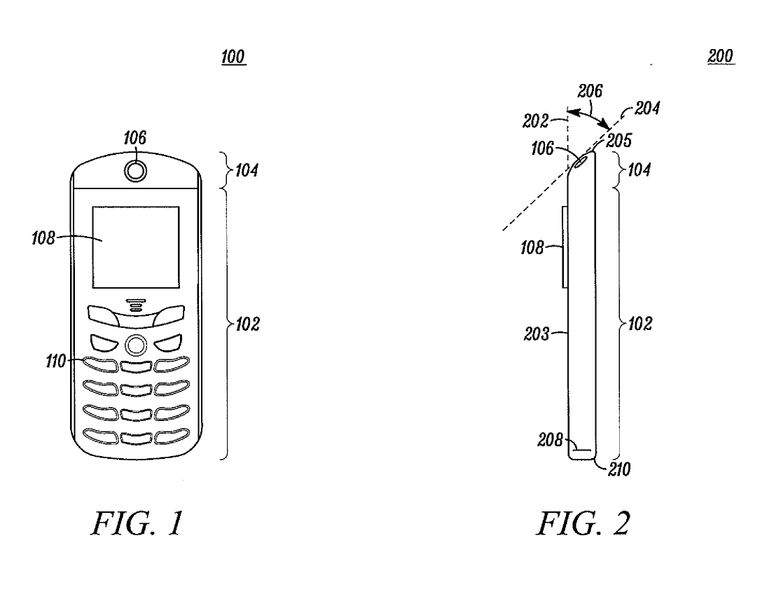

Referring now to FIG. 1, there is shown a front elevational view of a mobile communication device 100, in accordance with an embodiment of the invention. The mobile communication device has a user interface region 102 and an ear portion 104. The user interface region is an area of the mobile communication device which occupies a major surface of the mobile communication device, and where there may be disposed user interface elements such as a graphical display 108, and a key pad 110 for entering information and commands into the mobile communication device. The ear portion contains an acoustic port 106, through which acoustic signals are transmitted by an audio transducer disposed inside the mobile communication device. Generally, the user interface portion is substantially planar, and defines a user interface plane. In prior art designs the ear portion generally follows the plane of the user interface portion. However, according to the invention, the ear portion slopes away from the user interface plane to encourage the user to turn the body of the mobile communication device away from the user's head to form an acoustic seal between the ear portion and the user's ear.

The sloped ear portion can be better seen in FIG. 2, which shows a side elevational view of a mobile communication device 200 having a sloped ear portion 104, in accordance with an embodiment of the invention. The user interface portion 102 of the mobile communication device has a front side 203, where the main elements of the user interface may be disposed, including a graphical display 108, for example. The user interface surface is generally substantially flat, and defines a user interface plane along line 202. It can be seen that the ear portion 106 has an ear portion surface generally along line 204 which slopes away from the user interface plane, at some angle 206. The speaker port 106 is formed on the sloped ear portion surface, at a distance from the user interface plane 202. Upon using the mobile communication device to engage in communication, the angle between the ear portion surface and the user interface surface causes the user of the mobile communication device to hold the mobile communication device against the user's ear along the ear portion surface plane 204 to form an acoustic seal by having the top 205 of the mobile communication device towards the user's ear, and preferably in contact with the user's ear. By holding the mobile communication device against the user's ear along the ear portion surface plane, the user interface portion 102 is angled away from the user's head.

By encouraging the user to hold the main body of the mobile communication device away from the user's head, designers can, for example, place an internal antenna 208 in a bottom portion 210 of the mobile communication device. The resulting angle when held by the user then places the antenna farther away from the user's head, thereby improving radio frequency performance. Furthermore, since the main portion of the mobile communication device is not being held in contact with the user's face, the user will not feel the effects of any heat being generated by the transceiver of the mobile communication device that is often conducted out of the device through the user interface surface in prior art designs.

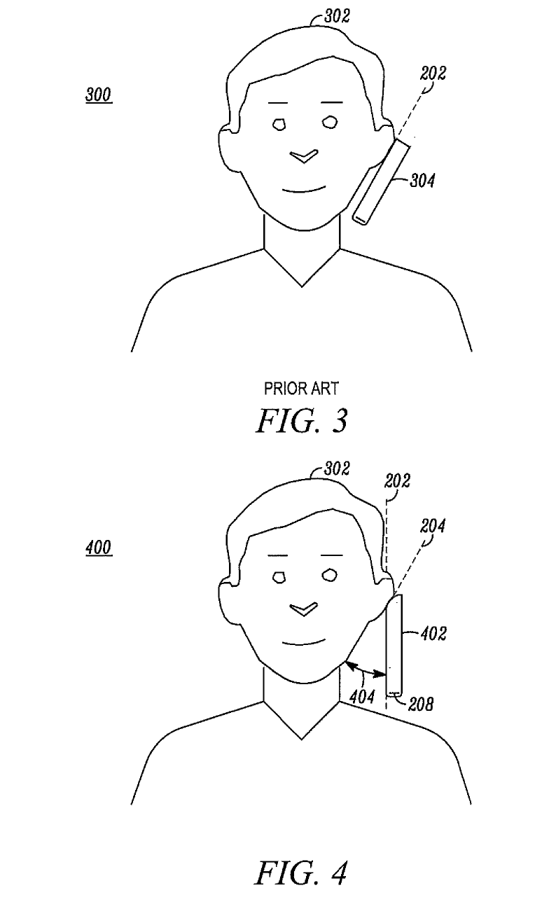

The difference is illustrated by FIGS. 3 and 4, which illustrate, respectively, a prior art design 300 and the present invention 400. In FIG. 3, a prior art design, a user head 302 is shown with a flat mobile communication device 304 being held to the user's head and ear for use. On a prior art mobile communication device, the ear portion surface is aligned and contiguous with the user interface plane 202, typically resulting in the user holding the mobile communication device with the user interface surface against or in close proximity to the user's cheek. Conversely, with the mobile communication device 402 designed in accordance with the invention, as in FIG. 4, the user aligns the ear portion surface 204 to the user's ear for better acoustic performance, resulting in an angle 404 between the user interface plane of the mobile communication device and the user. As a result of the physical separation between the main body of the mobile communication device and the user, there may be an increase in performance and a decrease in heat experienced by the user that would otherwise result from being in contact with the mobile communication device.

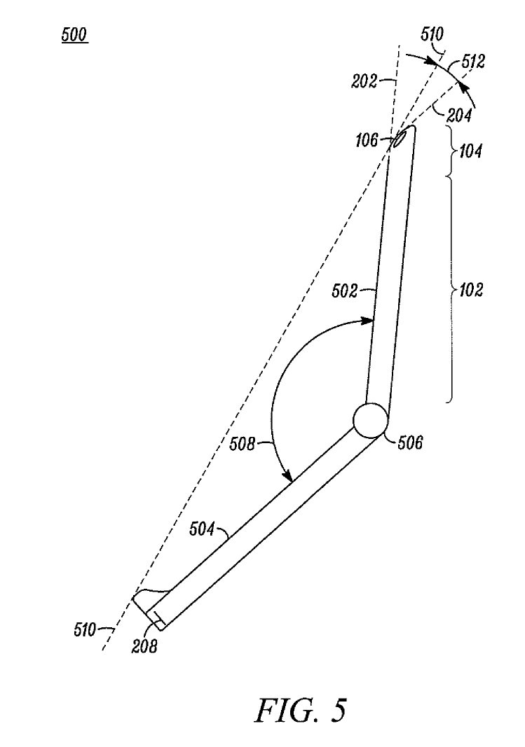

Referring now to FIG. 5, there is shown a clamshell mobile communication device 500 adapted to incorporate an embodiment of the invention. A clamshell mobile communication device is one which folds closed when not in use, and may be opened when used in communication. A typical clamshell mobile communication device has a folder portion 502 and a control portion 504 joined by a hinge section 506. The two body portions fold together, or apart, as indicated by arc 508. The folder portion 502 typically comprises a display on an inner surface or a user interface portion 102, which may define a user interface plane 202. An ear portion 104 has an acoustic port 106 on an ear portion surface, which defines an ear portion plane 204. The ear portion plane 204 slopes away from the user interface plane 202, and is therefore at an angle to the user interface surface. Furthermore, when the clamshell mobile communication device is fully opened for use, an axis 510 may be defined by a point at the border of the user interface surface and the ear portion surface, and the bottom of the mobile communication device where a microphone may be typically located. The ear portion surface is angled away from this axis, and indicated by arc 512. Thus, in a clamshell mobile communication device, the user interface surface may alternatively be defined along this axis since it is the axis of interest with regard to the angle of the ear portion surface in order to urge the user to hold the mobile communication device in a manner such that the bottom of the mobile communication device is held away from the user's head compared to a prior art design where the ear portion is not angled.

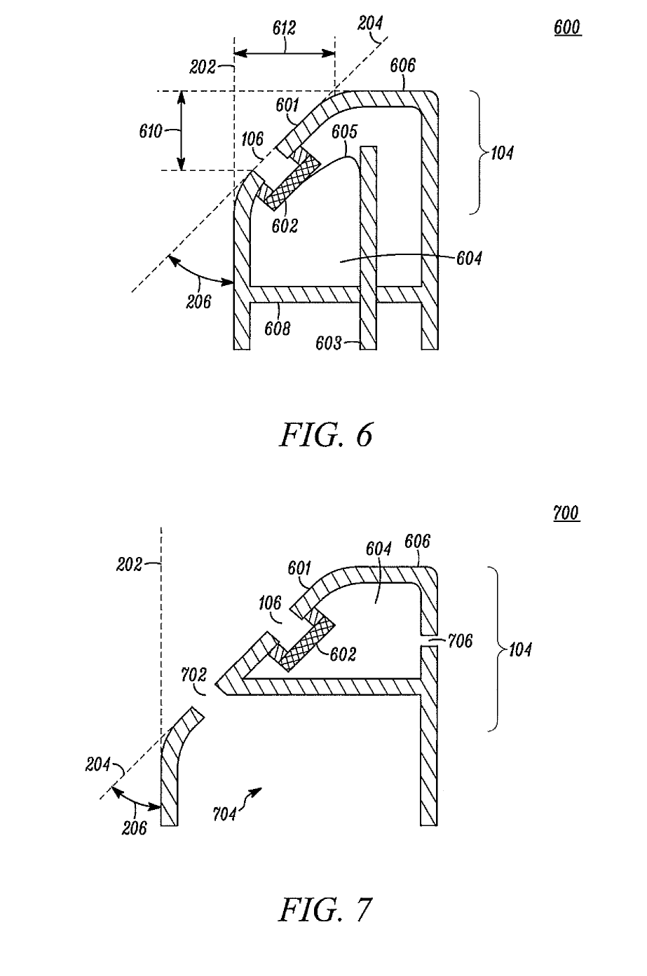

Referring now to FIG. 6, there is illustrated therein a side cut-away view 600 of an ear portion 104 of a mobile communication device, in accordance with an embodiment of the invention. In the present embodiment, the ear portion surface 601 defines a plane 204 which is generally at an angle 206 to a user interface plane 202. An acoustic port 106 is formed in the ear portion surface 601 to allow acoustic signals out of the mobile communication device. An acoustic transducer 602 is disposed inside the mobile communication device, and is mounted in such a way as to be sealed to the acoustic port 106. It will be appreciated by those skilled in the art that, although a single opening is shown in the present illustration, there may be multiple openings in a variety of shapes. Furthermore there may be additional elements, such as a felt cover between the transducer and the acoustic port, for example, as is practiced in the art.

The acoustic transducer may be connected to a circuit board 603 in an interior 604 of the mobile communication device by, for example, cantilevered contacts 60 which carry the electrical signals from the circuit board to the acoustic transducer. The acoustic port 106 is formed in the ear portion surface 601 between the top 606 of the mobile communication device and a point where the ear portion surface meets the user interface surface. It should be noted that other features may be disposed on the ear portion surface, such as ridges or ornamental features. Such features may be helpful in allowing the user to locate the acoustic port against their ear through tactile means.

The interior of the mobile communication device is defined by the external walls of the mobile communication device, and an internal wall 608 may be used for acoustic sealing. It has been found that the acoustic port 106 should be located at a distance from the top 606 by a distance 610, which is at least 5 millimeters, and preferably 13 millimeters. Furthermore, by virtue of the angle formed by the ear portion sloping away from the user interface surface, it can be seen that where the ear portion surface meets the top or terminal point 606 of the mobile communication device, there is a distance 612 from the user interface plane.

The embodiment illustrated in FIG. 7 is substantially similar to that of FIG. 6, with the addition of an acoustic relief port 702 which may lead to a different interior portion 704. The relief port prevents the user from sealing the acoustic port 106 against the user's ear canal, and allows an escape or relief through which acoustic signals may go. It has been found that a relief port balances the audio spectral distribution of the acoustic signal by preventing sealing. Thus, the relief port provides tolerance for various ear shapes and positions which the user may hold the mobile communication device against the ear. In the present illustration, it can further be seen that the acoustic transducer space 604 may be opened by a back port 706, through a back portion the mobile communication device, as shown, or internally. The port may facilitate acoustic tuning of the transducer to help provide the desired acoustic response, as is known.

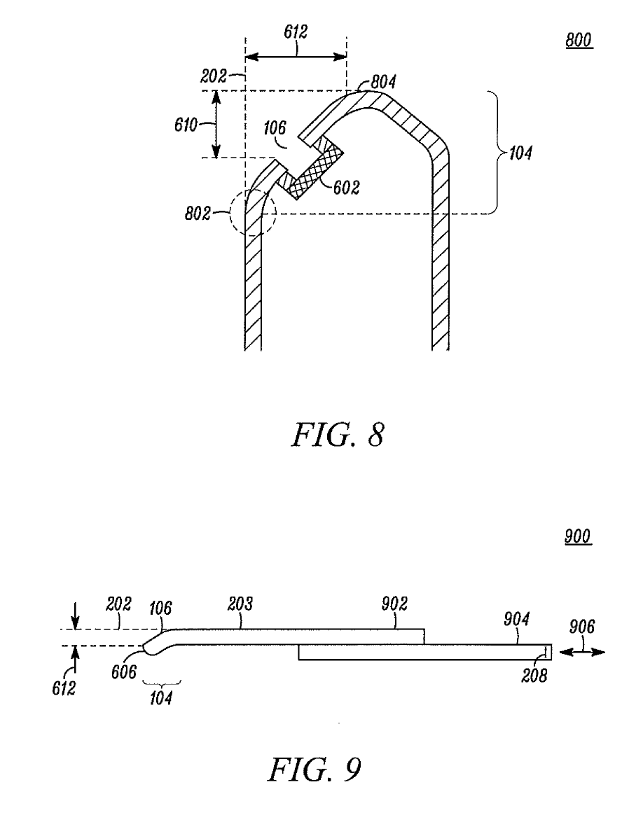

Referring now to FIG. 8, there is illustrated therein a side cut-away view 800 of an ear portion of a mobile communication device, in accordance with an alternate embodiment of the invention. In the present illustration, the ear portion surface, rather than having a flat surface, is curved in a convex shape or following some other spline curve. Furthermore, the point where the ear portion surface and the user interface surface meet is curved, rather than an abrupt transition, making the surfaces more comfortable to hold against the ear. Although the ear portion surface doesn't follow a particular plane, it still slopes away from the user interface plane, and at points along the ear portion surface at increasing distance from the user interface portion, those points will also be at increasing distances from the user interface plane 202.

Referring now to FIG. 9, there is shown therein a slider style mobile communication device 900, in accordance with an embodiment of the invention. The slider style mobile communication device has a first body portion 902 and a second body portion 904. These portions are slidably coupled together, and move relative to each other as indicated by arrow 906. As with other embodiments of the invention, the ear portion 104 has an ear portion surface that slopes away from a user interface plane 202, here defined by a front surface of the first body portion 902.

This invention can be embodied in other forms without departing from the spirit or essential attributes thereof. Accordingly, reference should be made to the following claims, rather than to the foregoing specification, as indicating the scope of the invention.

What is claimed is:

1. A mobile communication device, comprising:
a body portion having a user interface surface and defining a user interface plane;
an ear portion formed at a top end of the body portion contiguous with the user interface surface, the ear portion having an ear portion surface which slopes away from the user interface plane;
a speaker port formed in the ear portion at a distance from the user interface plane;
an audio transducer disposed in the ear portion for providing acoustic signals to a user of the mobile communication device through the speaker port; and
an antenna for transmitting and receiving signals, the antenna not being located in the ear portion of the mobile communication device;
wherein the distance of the speaker port from the user interface plane causes a user of the mobile communication device to align the ear portion surface with an ear of the user when using the mobile communication device during a call.

2. A mobile communication device as defined in claim 1, wherein the antenna is located at a bottom end of the mobile communication device.

3. A mobile communication device as defined in claim 1, wherein the user interface portion comprises a display having a flat surface substantially aligned along the user interface plane.

4. A mobile communication device as defined in claim 1, wherein the mobile communication device is a clamshell mobile communication device having a folding portion and a control portion, the user interface being defined on an inside of the folding portion.

5. A mobile communication device as defined in claim 4, wherein the antenna is disposed in the main body portion of the mobile communication device.

6. A mobile communication device as defined in claim 1, wherein the mobile communication device is slider style mobile communication device.

7. A mobile communication device as defined in claim 1, wherein the ear portion surface follows a spline curve.

8. A mobile communication device as defined in claim 1, wherein the ear portion surface is convex.

9. A mobile communication device as defined in claim 1, wherein the distance between the speaker port and a top portion of the mobile communication device is at least 5 millimeters.

10. A mobile communication device as defined in claim 9, wherein the distance between the speaker port and the top portion of the mobile communication device is substantially 13 millimeters.

11. A mobile communication device, comprising:
a user interface portion having a major surface defining a user interface plane;
an ear portion formed contiguous with the user interface portion and having an ear portion surface which slopes away from the user interface plane; and
an audio port formed through the ear portion surface at least 5 millimeters from a top portion of the mobile communication device.

12. A mobile communication device as defined in claim 11, further comprising an internal antenna disposed in the mobile communication device.

13. A mobile communication device as defined in claim 12, wherein the internal antenna is disposed at a bottom of the mobile communication device.

14. A mobile communication device as defined in claim 11, wherein the user interface portion comprises a display having a flat surface substantially aligned along the user interface plane.

15. A mobile communication device as defined in claim 11, wherein the mobile communication device is a clamshell mobile communication device having a folding portion and a control portion, the user interface being defined on an inside of the folding portion.

16. A mobile communication device as defined in claim 15, wherein the antenna is disposed in the main body portion of the mobile communication device.

17. A mobile communication device as defined in claim 11, wherein the mobile communication device is slider style mobile communication device.

18. A mobile communication device as defined in claim 11, wherein the ear portion surface follows a spline curve.

19. A mobile communication device as defined in claim 11, wherein the ear portion surface is convex.

20. A mobile communication device as defined in claim 11, wherein the distance between the speaker port and the top portion of the mobile communication device is substantially 13 millimeters.
